(19) United States
(12) Patent Application Publication
(10) Pub. No.: US 2026/0015103 A1
(43) Pub. Date: Jan. 15, 2026

(54) Adjustment device for adjusting the mounting of a first aircraft part on a second aircraft part, aircraft cabin and associated method

(71) Applicant: DASSAULT AVIATION, PARIS (FR)

(72) Inventors: Gregory LEFLOCH, Little Rock, AR (US); Josh TIMMERMAN, Little Rock, AR (US); Olivier CAPISTRAN, Little Rock, AR (US); Yann MAILLAUT, SAINT CLOUD (FR)

(21) Appl. No.: 19/262,566

(22) Filed: Jul. 8, 2025

(30) Foreign Application Priority Data
Jul. 12, 2024 (FR) FR 24 07661

(51) Int. Cl. B64F 5/10; B64D 11/00

(52) U.S. Cl. CPC B64F 5/10; B64D 2011/0046

(57) ABSTRACT

An adjustment device for adjusting the mounting of a first aircraft part on a second aircraft part, aircraft cabin and associated method, the device including a base body and an external adjustment member, configured to be mounted on the base body in an external angular position chosen from a plurality of predefined external angular positions. The device also includes an internal adjustment member, configured to be mounted on the external adjustment member in an internal angular position chosen from a plurality of predefined internal angular positions around an internal position adjustment axis, offset relative to the external position adjustment axis. For each predefined internal angular position, the internal adjustment member is configured to be placed in an elevation position chosen from a plurality of predefined elevation positions relative to the base body along the internal position adjustment axis.

### TECHNICAL FIELD

The present disclosure relates to an adjustment device for adjusting the mounting of a first aircraft part on a second aircraft part, comprising:
a base body, intended to be fastened onto the first part;
an external adjustment member, configured to be mounted on the base body in an external angular position chosen from a plurality of predefined external angular positions around an external position adjustment axis;
an internal adjustment member, configured to be mounted on the external adjustment member in an internal angular position chosen from a plurality of predefined internal angular positions around an internal position adjustment axis, the internal position adjustment axis being decentered relative to the external position adjustment axis, the second part being intended to be fastened onto the internal adjustment member.

Such a device is particularly intended to connect the first part and the second part by compensating for manufacturing and positioning plays, e.g. within an aircraft cabin.

The first part is for example a first interior trim part of the cabin, particularly a lateral cabin trim part. The second part is advantageously a second interior trim part of the cabin, particularly a window panel, and/or is a structural part of the fuselage, such as a spar and/or a rib.

### BACKGROUND

The assembly of an aircraft cabin structure and the interior trim of this structure is generally carried out while respecting manufacturing and assembly tolerances that allow for some flexibility, given the complexity of the parts involved and the strong mechanical stresses applied particularly to the aircraft structure.

Nevertheless, for functional and aesthetic reasons, it is necessary to precisely position certain trim parts, such as lateral cabin trim parts, relative to other parts, such as window panels.

In this context, it is sometimes necessary to compensate for the plays resulting from the manufacturing tolerances of the parts and/or the assembly tolerances between the parts to allow for a more precise adjustment of one part on another.

To do this, it is known to use an adjustment device of the aforementioned type, wherein the operator fastens the body of the device onto the first part. The operator then adjusts the angular position of an external disc relative to the body around the external adjustment axis, and the angular position of an internal disc relative to the external adjustment member around the internal adjustment axis. The second part is then mounted on the internal adjustment member.

Since the adjustment axes are decentered, it is possible to adjust the position of the first part relative to the second part in a plane perpendicular to the adjustment axes by modifying the angular position of the internal and external discs.

Such an adjustment device does not provide complete satisfaction. Indeed, plays between the first part and the second part can also exist outside the adjustment plane offered by the aforementioned adjustment device. The operator often has to perform combined actions in the adjustment plane and along the axis perpendicular to the adjustment plane.

In this case, the operator sometimes has to perform a succession of adjustment and disassembly steps before achieving a satisfactory functional and aesthetic adjustment. This is tedious and slows down the assembly of the trim.

### SUMMARY

A goal of the present disclosure is to provide an adjustment device that is simple to use and that easily and accurately compensates for the plays between the first part and the second part, along three axes.

To this end, the present disclosure relates to an adjustment device as defined above, characterized in that, for each predefined internal angular position, the internal adjustment member is configured to be placed in an elevation position chosen from a plurality of predefined elevation positions relative to the base body along the internal position adjustment axis.

The adjustment device according to the present disclosure may comprise one or more of the following features, taken alone or in any technically possible combination:
the external adjustment member is mounted in the base body via a helical connection along the external position adjustment axis and/or wherein the internal adjustment member is mounted in the external adjustment member via a helical connection along the internal position adjustment axis;
the external adjustment member comprises a peripheral surface provided with a thread, the base body comprising a receiving housing for receiving the external adjustment member provided with a complementary thread configured to cooperate with the thread on the external adjustment member and to form the helical connection between the external adjustment member and the base body, and/or wherein the internal adjustment member comprises a peripheral surface provided with a thread, the external adjustment member comprising an insertion hole for the internal adjustment member provided with a complementary thread configured to cooperate with the thread on the internal adjustment member and to form the helical connection between the internal adjustment member and the external adjustment member;
the device comprises a reversible locking mechanism for reversibly locking the external adjustment member, the reversible locking mechanism being configured to lock the external adjustment member and the internal adjustment member in the chosen elevation position;
the reversible locking mechanism for reversibly locking the external adjustment member comprises splines extending from the external adjustment member, the splines protruding radially relative to the internal position adjustment axis by defining intermediate spaces, the reversible locking mechanism comprising at least one locking rod mounted in the base body and received in an intermediate space between two splines, advantageously at least two locking rods mounted removably in the base body and received in a respective intermediate space between two splines;
the adjustment device comprises a reversible locking mechanism for reversibly locking the internal adjustment member relative to the external adjustment member in the chosen angular position;
the reversible locking mechanism for locking the internal adjustment member relative to the external adjustment member comprises a first indexing ring of the internal adjustment member relative to the external adjustment member extending around the internal position adjustment axis on one of the internal adjustment member and the external adjustment member, and at least one cooperating member for cooperating with the first indexing ring, protruding towards the first indexing ring from the other of the internal adjustment member and the external adjustment member;
the reversible locking mechanism for reversibly locking the internal adjustment member relative to the external adjustment member comprises a second indexing ring extending around the internal position adjustment axis on the other of the internal adjustment member and the external adjustment member, the second indexing ring comprising a plurality of cooperating members for cooperating with the first indexing ring protruding towards the second indexing ring;
the adjustment device comprises a system for fastening the second part onto the internal adjustment member, the system for fastening the second part onto the internal adjustment member being decentered relative to the internal position adjustment axis;
the system for fastening the second part onto the internal adjustment member comprises a fastening housing provided in the internal adjustment member away from the internal position adjustment axis, and a reversible fastening member of the second part, configured to be reversibly fastened in the fastening housing;
the base body comprises a plate, the adjustment device including a reversible fastening system for reversibly fastening the plate onto the first part.

The present disclosure also relates to an aircraft cabin comprising a first part, a second part, and a device as defined above, connecting the first part to the second part.

The aircraft cabin according to the present disclosure may comprise one or more of the following features, taken alone or in any technically possible combination:
the first part is a first trim part of the aircraft cabin, particularly a lateral cabin trim of the aircraft cabin, the second part being a second trim part of the aircraft cabin, particularly a window panel.

The present disclosure also relates to a method for adjusting a first part onto a second part in an aircraft cabin, the method comprising the following steps:
providing an adjustment device as defined above;
fastening the base body onto the first part;
mounting the external adjustment member on the base body in an external angular position chosen from a plurality of predefined external angular positions around the external position adjustment axis;
mounting the internal adjustment member on the external adjustment member in an internal angular position chosen from a plurality of predefined internal angular positions around the internal position adjustment axis; characterized by placing the internal adjustment member in an elevation position chosen from a plurality of predefined elevation positions relative to the base body along the internal position adjustment axis.

The adjustment method according to the present disclosure may comprise one or more of the following features, taken alone or in any technically possible combination:
the external adjustment member is mounted in the base body via a helical connection along the external position adjustment axis, placing the internal adjustment member in the chosen elevation position relative to the base body comprising rotating the external adjustment member relative to the base body around the external position adjustment axis via the helical connection and/or wherein the internal adjustment member is mounted in the external adjustment member via a helical connection along the internal position adjustment axis, placing the internal adjustment member in the chosen elevation position relative to the base body comprising rotating the internal adjustment member relative to the external adjustment member around the internal position adjustment axis via the helical connection.

### BRIEF SUMMARY OF THE DRAWINGS

The present disclosure will be better understood by reading the following description, given solely by way of example, and made with reference to the appended drawings, wherein:

FIG. 1 is a partial sectional view of a detail of an aircraft cabin comprising a first part assembled on a second part and a first adjustment device according to the present disclosure, connecting the first part to the second part;

FIG. 2 is a view similar to FIG. 1, taken in section along a median axial plane of the adjustment device;

FIG. 3 is a perspective view of the various components of the adjustment device in an assembled configuration; and

FIG. 4 is a view similar to FIG. 3, in a disassembled configuration.

### DETAILED DESCRIPTION

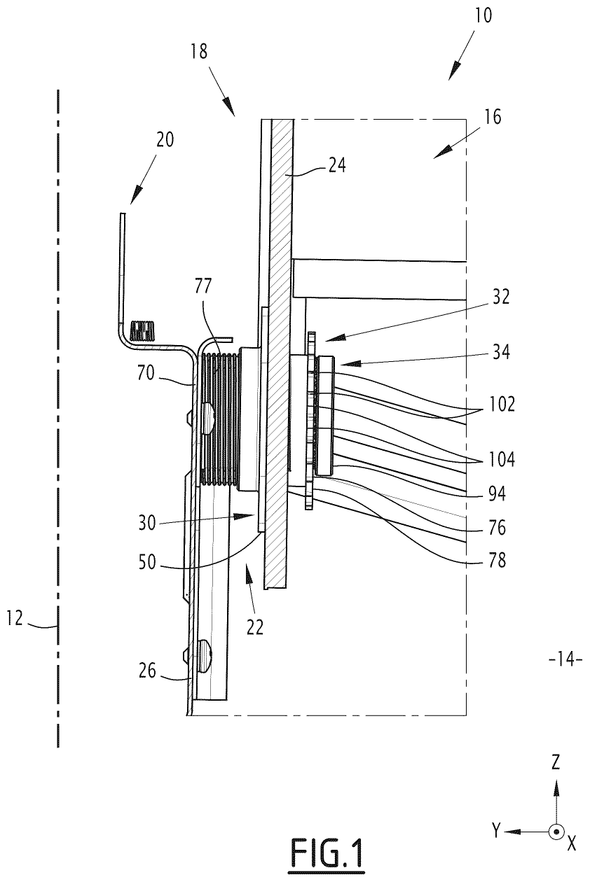

A detail of an aircraft cabin 10 according to the present disclosure is illustrated in FIG. 1. The aircraft cabin 10 is delimited inside a fuselage 12 of the aircraft schematically represented in FIG. 1.

The aircraft cabin 10 delimits a central interior space 14 wherein the crew and passengers of the aircraft move.

The interior space 14 of the cabin 10 extends along a longitudinal axis X of the aircraft, visible in FIG. 1. In the cabin 10, the interior space 14 is delimited laterally and vertically by the fuselage 12 along a transverse axis Y transverse to the longitudinal axis X and along a vertical axis Z perpendicular to the longitudinal axis X.

The aircraft cabin 10 is provided with an internal trim 16 that extends along the fuselage 12. In this example, the internal trim 16 comprises at least a first part 18 and a second part 20, the first part 18 being assembled on the second part 20.

The aircraft cabin 10 further comprises an adjustment device 22 according to the present disclosure, interposed between the first part 18 and the second part 20.

The first part 18 is e.g. a lateral trim of the aircraft, extending longitudinally along the fuselage 12 from a cabin floor. In a known manner, the lateral trim comprises e.g. supports and/or housings for at least one table, an object receiving housings and/or at least one object storage compartment.

The first part 18 comprises at least one outer wall 24 intended to be assembled on the second part 20. In this example, the outer wall 24 generally extends along a vertical plane, parallel to the plane defined by the longitudinal axis X and the vertical axis Z.

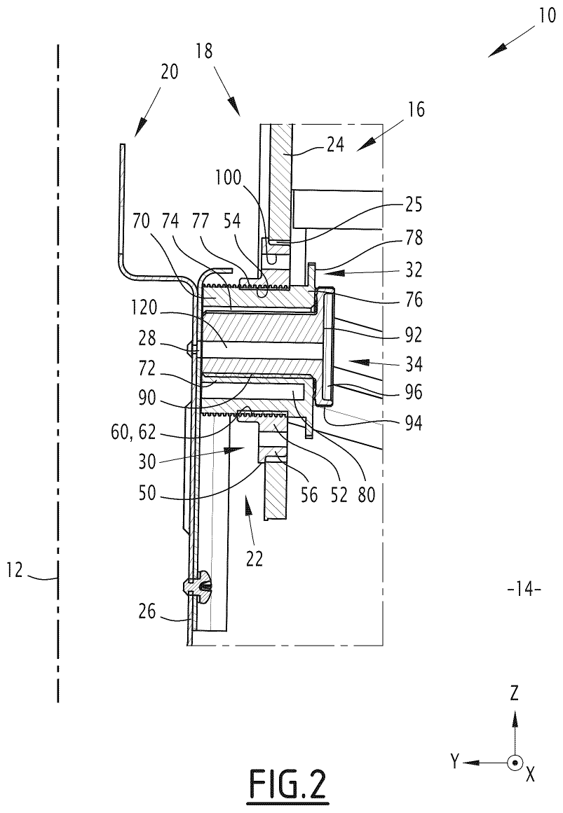

The outer wall 24 defines at least one receiving housing 25 for receiving the adjustment device 22 (visible in FIG. 2).

The second part 20 is e.g. a window panel that is fastened onto the fuselage 12 of the aircraft. The window panel particularly comprises a support wall 26 that extends parallel to the outer wall 24 of the first part 18.

The support wall 26 is here formed by two profiles assembled on each other. It defines at least one assembly opening 28 for assembling the adjustment device on the second part 20 (visible in FIG. 2).

As illustrated by FIGS. 1 and 2, the adjustment device 22 connects the first part 18 to the second part 20. Said device compensates for the positioning and manufacturing plays between the first part 18 and the second part 20 in the plane formed by the axes X and Z, and also, according to the present disclosure, along an elevation axis that is here parallel to the transverse axis Y.

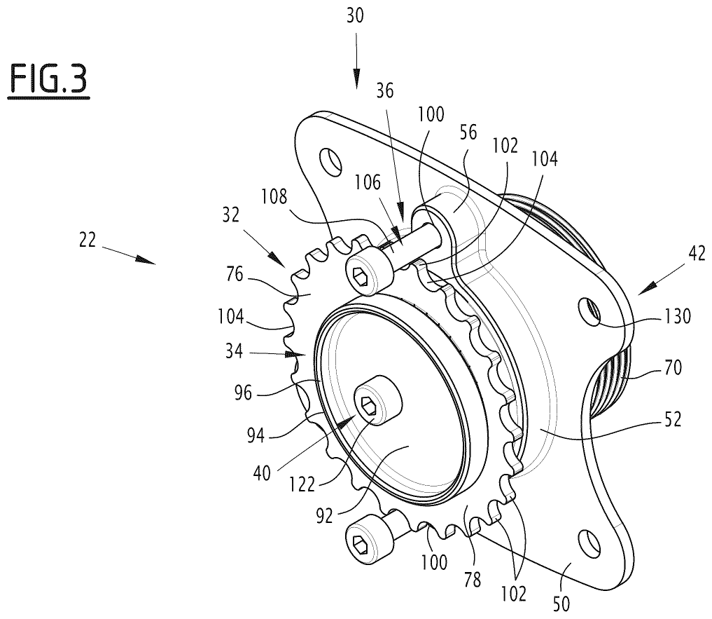

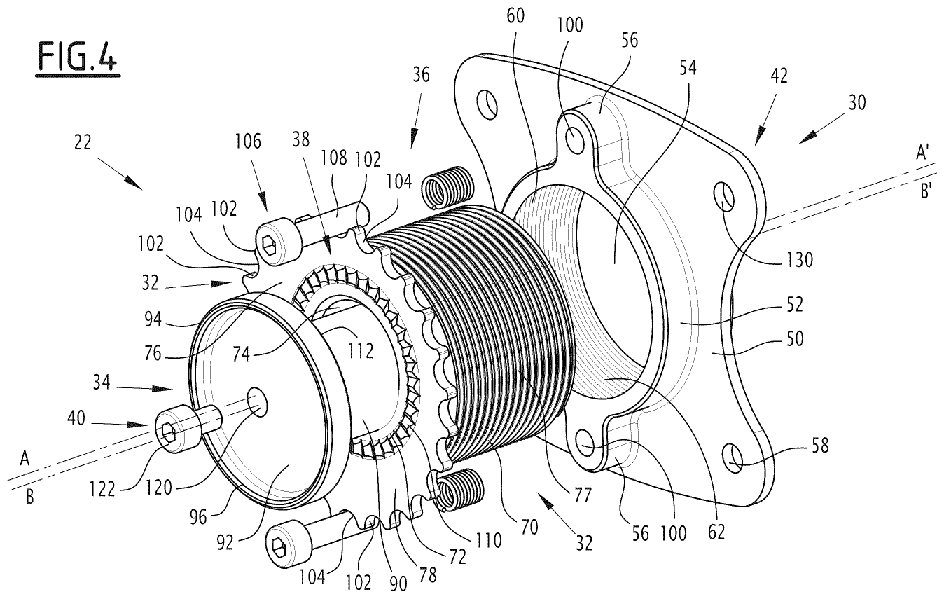

As illustrated by FIGS. 3 and 4, the adjustment device 22 includes a base body 30 fastened onto the second part 20 being partially inserted into the housing 25, an external adjustment member 32 configured to be mounted on the base body 30 in an external angular position chosen from a plurality of predefined external angular positions around an external position adjustment axis A-A′.

The adjustment device 22 further comprises an internal adjustment member 34, configured to be mounted on the external adjustment member 32 in an internal angular position chosen from a plurality of predefined internal angular positions around an internal position adjustment axis B-B′.

The adjustment device 22 also includes a locking mechanism 36 for locking the external adjustment member 32 relative to the base body 30 in the chosen external angular position, and in the chosen elevation position, and a locking mechanism 38 for locking the internal adjustment member 34 relative to the external adjustment member 32 in the chosen internal angular position (visible in FIG. 4).

Said device comprises a system 40 for fastening the second part 20 onto the internal adjustment member 34 and a system 42 for fastening the base body 30 onto the first part 18.

As will be seen below, the external adjustment member 32, and also the internal adjustment member 34 are configured to be placed in an elevation position chosen from a plurality of predefined elevation positions relative to the body along the external position adjustment axis A-A′ and the internal position adjustment axis B-B′.

As illustrated by FIG. 4, the base body 30 includes a mounting plate 50 on the first part 18, a central skirt 52 protruding relative to the mounting plate 50, defining a through housing 54 for receiving the external adjustment member 32 and at least one sleeve 56 for receiving a fastening member of the locking mechanism 36 of the external adjustment member 32 in the chosen angular position.

The plate 50 protrudes laterally from the central skirt 52 and the sleeves 56.

The central skirt 52 and the sleeves 56 define a relief of complementary shape to the receiving housing 25 provided in the outer wall 24 of the first part 18. Thus, the central skirt 52 and the sleeves 56 are configured to be inserted into the housing 25, the plate 50 being pressed against the outer wall 24 at the periphery of the housing 25.

As visible in FIG. 4, the central skirt 52 has a peripheral internal surface 60 delimiting the receiving housing 54.

The peripheral internal surface 60 is provided here with a thread 62 intended to cooperate with the external adjustment member 32.

The receiving housing 54 thus has a circular cross-section, and a central axis that forms the external position adjustment axis A-A′ of the external adjustment member 32.

The sleeves 56 extend here in the extension of the central skirt 52, protruding radially relative to the central skirt 52.

In the example shown in FIG. 4, the base body 30 includes two sleeves 56 diametrically opposite relative to the external position adjustment axis A-A′.

The external adjustment member 32 includes a cylindrical barrel 70, configured to be inserted into the receiving housing 54, an internal sleeve 72 visible particularly in FIG. 2, disposed in the barrel 70 being decentered relative to the barrel 70, the internal sleeve 72 delimiting an insertion hole 74 for the internal adjustment member 34.

The external adjustment member 32 further comprises a transverse wall 76 substantially perpendicular to the external position adjustment axis A-A′ and connecting an edge of the barrel 70 to an edge of the internal sleeve 72.

The barrel 70 is cylindrical with an axis corresponding to the external position adjustment axis A-A′.

The barrel 70 externally delimits a thread 77 intended to cooperate with the thread 62 delimited on the peripheral internal surface 60 of the receiving housing 54.

Thus, by the cooperation between the threads 62, 77, the external adjustment member 32 is mounted in the base body 30 following a helical connection of axis A-A′ corresponding to the external position adjustment axis, which allows for an adjustment of the external angular position of mounting thereof relative to the base body 30, and also of the elevation position relative thereof to the base body 30, along the external position adjustment axis A-A′.

The internal sleeve 72 is also cylindrical and is offset relative to the external position adjustment axis A-A′ along an axis corresponding to the internal position adjustment axis B-B′.

The external position adjustment axis A-A′ and the internal position adjustment axis B-B′ are thus parallel to each other being decentered from each other. They extend here perpendicularly to the plane formed by the axes X and Z.

Here, the insertion hole 74 is through. Said insertion hole also has a cylindrical shape with an axis corresponding to the internal position adjustment axis B-B′. The insertion hole 74 opens through the transverse wall 76.

The transverse wall 76 extends radially beyond the barrel 70 defining a collar 78. The transverse wall 76 closes the intermediate space 80 between the internal sleeve 72 and the insertion hole 74.

The internal adjustment member 34 includes a cylinder 90 inserted into the insertion hole 74 and a head 92, protruding out of the insertion hole 74 to rest on the transverse wall 76.

The cylinder 90 is movable in translation along the axis B-B′ of the insertion hole 74. The cylinder 90 is also movable in rotation around the internal position adjustment axis B-B′ when the head 92 is located away from the transverse wall 76.

The head 92 protrudes radially beyond the cylinder 90, at one end of the cylinder 90.

In this example, it has a protruding peripheral edge 94 that defines a cup 96, opening away from the insertion hole 74.

The locking mechanism 36 of the external adjustment member 32 relative to the base body 30 is configured to lock the external adjustment member 32 relative to the body in the chosen external angular position, and in the chosen elevation position.

In this example, the same locking mechanism 36 simultaneously locks the external adjustment member 32 relative to the base body 30 in rotation around the external position adjustment axis A-A′ and in translation along this axis A-A′.

In this example, said locking mechanism 36 includes for each sleeve 56, a tapped hole 100 provided in the sleeve 56, and splines 102 arranged along the peripheral edge of the collar 78, the splines 102 delimiting between them intermediate spaces 104 two by two.

The locking mechanism 36 further includes, for each tapped hole 100, a locking member 106 including a rod 108 intended to be inserted into the tapped hole, and to be indexed in an intermediate space 104 between two splines 102.

Each intermediate space 104 between two splines 102 defines a predefined external annular position of mounting around the external position adjustment axis A-A′. Each intermediate space 104 defines a distinct angular orientation of the insertion hole 74 of the internal adjustment member 34 around the axis A-A′.

The locking mechanism 38 of the internal adjustment member 34 on the external adjustment member 32 includes in this example a first toothed ring 110, carried by the external adjustment member 32, at the transverse wall 76 and a second toothed ring 112 carried by the internal adjustment member 34 under the head 92 opposite the cup 96.

The respective teeth of the first toothed ring 110 and the second toothed ring 112 define a plurality of predefined internal angular positions of mounting around the internal position adjustment axis B-B′.

Thus, the internal adjustment member 34 can be pivoted relative to the external adjustment member 32 by disengagement of the first toothed ring 110 relative to the second toothed ring 112 and can be locked in the chosen internal angular position by re-engagement of the first toothed ring 110 in the second toothed ring 112.

The fastening system 40 of the second part 20 on the internal adjustment member 34 comprises a decentered fastening housing 120 provided in the internal adjustment member 34, and a fastening member 122 intended to be inserted through the fastening housing 120 to engage in the assembly opening 28 on the second part 20.

The fastening housing 120 extends parallel to the internal position adjustment axis B-B′ which constitutes the central axis of cylinder 90.

It opens into the head 92 and opposite, at the free end of the cylinder 90. The angular orientation of the fastening housing 120 around the internal position adjustment axis B-B′ can be adjusted by choosing a chosen angular position from the plurality of predefined internal angular positions of mounting.

Thus, by choosing a chosen external angular position from the plurality of predefined external angular positions of mounting around the axis A-A′ and by choosing a chosen internal angular position from a plurality of predefined internal angular positions of mounting around the axis B-B′, it is possible to move the fastening housing 120 in a plane perpendicular to the axes A-A′ and B-B′.

It is thus possible to adjust the relative position of the fastening housing 120 relative to the assembly opening 28 in a simple manner. Furthermore, the rotation of the external adjustment member 32 relative to the base body 30 in the housing 54 by cooperation between the threads 62, 77 allows the elevation position of the external adjustment member 32 and the internal adjustment member 34 to be adjusted along the internal position adjustment axis B-B′ to apply the free edge of the internal adjustment member 34 against the support wall 26.

The fastening system 42 of the base body 30 on the first part 18 comprises a plurality of through holes 130 provided in the plate 50, a plurality of tapped holes (not shown), provided in the outer wall 24 coinciding with the through holes 130, and fastening members (not shown) mounted through the holes 130 and housed in the tapped holes.

A method for mounting the first aircraft part 18 on the second aircraft part 20 will now be described.

Initially, the first aircraft part 18 is provided, the second aircraft part 20 having been previously mounted on the fuselage 12 of the aircraft.

The adjustment device 22 is then mounted on the first part 18. The central skirt 52 and each sleeve 56 of the base body 30 is inserted into the housing 25 provided in the outer wall 24. The fastening members of the fastening system 42 are inserted through the through holes 130 and are screwed into the corresponding tapped holes provided in the support wall 26.

The plate 50 is then held fixedly applied against the outer wall 24, the external adjustment member 32 being inserted into the receiving housing 54 and the internal adjustment member 34 being inserted into the external adjustment member 32.

The first part 18 is then brought near the second part 20 and is positioned relative to the second part 20.

Given the manufacturing and assembly plays, the fastening housing 120 provided in the internal adjustment member 34 is not necessarily aligned with the assembly opening 28 provided in the support wall 26.

Furthermore, the internal adjustment member 34 is not necessarily disposed in non-stressed support on the support wall 26 of the second part 20, around the assembly opening 28.

The operator therefore proceeds to the adjustment at mounting. The operator thus rotates the external adjustment member 32 relative to the base body 30 around the axis A-A′, until placing the internal adjustment member 34 in a chosen elevation position relative to the base body 30 along the internal position adjustment axis B-B′, wherein advantageously the internal adjustment member 34 is placed in non-stressed support on the support wall 26 of the second part 20, around the assembly opening 28.

Furthermore, to coincide the fastening housing 120 with the assembly opening 28, the operator rotates the external adjustment member 32 around the axis A-A′ following an angular displacement of less than 360° to a chosen predefined external angular position of mounting around the axis A-A′ and/or rotates the internal adjustment member 34 relative to the external adjustment member 32 around the axis B-B′, to a chosen predefined internal angular position of mounting around the axis B-B′.

Once this action is performed, the operator activates the locking mechanism 38 of the internal adjustment member 34 relative to the external adjustment member 32 by cooperation between the first toothed ring 110 and the second toothed ring 112.

The operator then inserts a locking member 106 through an intermediate space 104 between two splines 102 aligned with the tapped hole 100 provided in each sleeve 56. This locks in rotation and translation the external adjustment member 32 relative to the base body 30 along the axis A-A′ by thus activating the locking mechanism 36.

The adjustment device 22 that connects the first part 18 to the second part 20 thus compensates for any positioning and/or manufacturing plays between the first part 18 and the second part 20. This compensation of the plays exists both in a plane perpendicular to the axis of fastening of the first part 18 relative to the second part 20, and also along the axis of fastening of the first part 18 relative to the second part 20, to achieve a non-stressed contact between the first part 18 and the second part 20.

The adjustment is made along three axes, which simplifies the mounting of the first part 18 on the second part 20. The assembly is simple, and requires only one action, instead of two combined actions.

Alternatively, the internal adjustment member 34 is connected to the external adjustment member 32 by a helical connection allowing for the translation and rotation movement of the internal adjustment member 34 relative to the external adjustment member 32 along the internal position adjustment axis B-B′. The connection between the external adjustment member 32 and the base body 30 is then not necessarily a helical connection.

What is claimed is:

1. An adjustment device for adjusting mounting of a first aircraft part on a second aircraft part, the adjustment device comprising:
a base body, configured to be fastened onto the first aircraft part;
an external adjustment member, configured to be mounted on the base body in an external angular position chosen from a plurality of predefined external angular positions around an external position adjustment axis; and
an internal adjustment member, configured to be mounted on the external adjustment member in an internal angular position chosen from a plurality of predefined internal angular positions around an internal position adjustment axis, the internal position adjustment axis being decentered relative to the external position adjustment axis, the second aircraft part being configured to be fastened onto the internal adjustment member,
wherein, for each predefined internal angular position, the internal adjustment member is configured to be placed in an elevation position chosen from a plurality of predefined elevation positions relative to the base body along the internal position adjustment axis.

2. The adjustment device according to claim 1, wherein the external adjustment member is mounted in the base body via a helical connection along the external position adjustment axis and/or wherein the internal adjustment member is mounted in the external adjustment member via a helical connection along the internal position adjustment axis.

3. The adjustment device according to claim 2, wherein the external adjustment member comprises a peripheral surface provided with a thread, the base body comprising a receiving housing for receiving the external adjustment member provided with a complementary thread configured to cooperate with the thread on the external adjustment member and form the helical connection between the external adjustment member and the base body, and/or wherein the internal adjustment member comprises a peripheral surface provided with a thread, the external adjustment member comprising an insertion hole for the internal adjustment member provided with a complementary thread configured to cooperate with the thread on the internal adjustment member and form the helical connection between the internal adjustment member and the external adjustment member.

4. The adjustment device according to claim 1, further comprising a reversible locking mechanism for reversibly locking the external adjustment member, the reversible locking mechanism being configured to lock the external adjustment member and the internal adjustment member in the chosen elevation position.

5. The adjustment device according to claim 4, wherein the reversible locking mechanism for reversibly locking the external adjustment member comprises splines extending from the external adjustment member, the splines protruding radially relative to the internal position adjustment axis by defining intermediate spaces, the reversible locking mechanism comprising at least one locking rod mounted in the base body and received in an intermediate space between two splines.

6. The adjustment device according to claim 5, wherein the at least one locking rod is at least two locking rods mounted removably in the base body and received in a respective intermediate space between the two splines.

7. The adjustment device according to claim 4, further comprising a reversible locking mechanism for reversibly locking the internal adjustment member relative to the external adjustment member in the chosen angular position.

8. The device according to claim 7, wherein the reversible locking mechanism for locking the internal adjustment member relative to the external adjustment member comprises a first indexing ring of the internal adjustment member relative to the external adjustment member extending around the internal position adjustment axis on one of the internal adjustment member and the external adjustment member, and at least one cooperating member for cooperating with the first indexing ring, protruding towards the first indexing ring from the other of the internal adjustment member and the external adjustment member.

9. The adjustment device according to claim 8, wherein the reversible locking mechanism for reversibly locking the internal adjustment member relative to the external adjustment member comprises a second indexing ring extending around the internal position adjustment axis on the other of the internal adjustment member and the external adjustment member, the second indexing ring comprising a plurality of cooperating members for cooperating with the first indexing ring protruding towards the second indexing ring.

10. The adjustment device according to claim 1, further comprising a system for fastening the second aircraft part onto the internal adjustment member, the system for fastening the second aircraft part onto the internal adjustment member being decentered relative to the internal position adjustment axis.

11. The adjustment device according to claim 10, wherein the system for fastening the second aircraft part onto the internal adjustment member comprises a fastening housing provided in the internal adjustment member away from the internal position adjustment axis, and a reversible fastening member of the second aircraft part, configured to be reversibly fastened in the fastening housing.

12. The adjustment device according to claim 1, wherein the base body comprises a plate, the adjustment device including a reversible fastening system for reversibly fastening the plate onto the first aircraft part.

13. An aircraft cabin comprising:
a first aircraft part;
a second aircraft part; and
the adjustment device according to claim 1, the adjustment device connecting the first aircraft part to the second aircraft part.

14. The aircraft cabin according to claim 13, wherein the first aircraft part is a first trim part of the aircraft cabin, the second aircraft part being a second trim part of the aircraft cabin.

15. The aircraft cabin according to claim 14, wherein the first aircraft part is a lateral cabin trim of the aircraft cabin.

16. The aircraft cabin according to claim 14, wherein the second aircraft part is a window panel.

17. A method for mounting a first aircraft part on a second aircraft part in an aircraft cabin, the method comprising:
providing the adjustment device according to claim 1;
fastening the base body onto the first aircraft part;
mounting the external adjustment member on the base body in an external angular position chosen from a plurality of predefined external angular positions around the external position adjustment axis;
mounting the internal adjustment member on the external adjustment member in an internal angular position chosen from a plurality of predefined internal angular positions of mounting around the internal position adjustment axis; and
placing the internal adjustment member in an elevation position chosen from a plurality of predefined elevation positions relative to the base body along the internal position adjustment axis.

18. The method according to claim 17, wherein the external adjustment member is mounted in the base body via a helical connection along the external position adjustment axis, placing the internal adjustment member in the chosen elevation position relative to the base body comprising rotating the external adjustment member relative to the base body around the external position adjustment axis via the helical connection and/or wherein the internal adjustment member is mounted in the external adjustment member via a helical connection along the internal position adjustment axis, placing the internal adjustment member in the chosen elevation position relative to the base body comprising rotating the internal adjustment member relative to the external adjustment member around the internal position adjustment axis via the helical connection.
